(19) United States
(12) Patent Application Publication
(10) Pub. No.: US 2009/0167752 A1
(43) Pub. Date: Jul. 2, 2009

(54) PLASMA DISPLAY PANEL DRIVING METHOD AND PLASMA DISPLAY DEVICE

(76) Inventors: Akihiro Takagi, Miyazaki (JP); Tetsuya Sakamoto, Miyazaki (JP)

Correspondence Address: MCDERMOTT WILL & EMERY LLP, 600 13TH STREET, N.W., WASHINGTON, DC, 20005-3096, US

(21) Appl. No.: 12/300,892

(22) PCT Filed: Aug. 9, 2006
(86) PCT No.: PCT/JP2006/315722

§ 371 Date: Nov. 14, 2008

(51) Int. Cl. G09G 5/00; G09G 3/28

(52) U.S. Cl. 345/214; 345/60

(57) ABSTRACT

A technique capable of enhancing performance of a reset operation by a reset waveform using a step-wise rectangular wave and obtaining stable display characteristics in a subfield drive control of a PDP device is provided. In the PDP driving method, in the drive control of the subfield, a reset waveform including a rectangular wave raised in a plurality of steps in a step-wise manner is used in the reset operation, and the application timing of a partial waveform having one or more steps previous to a second step in the rectangular wave is shifted according to the number of sustains previous to the reset operation.

### TECHNICAL FIELD

The present invention relates to a technique of a display device (plasma display device: PDP device) including a plasma display panel (PDP), in particular, to a reset operation in a subfield drive control.

### BACKGROUND ART

In the drive control of fields and subfields of conventional PDP devices, a technique of applying a reset waveform using a rectangular wave rising in a step-wise manner by a plurality of (n) steps is known for the operation of a reset period. In the technique of the reset waveform, a constant application timing and a waveform shape are obtained without depending on the number of sustains (number of sustains discharges or number of unit sustain pulse applications) and the like of the sustain period before reset.

There is disclosed a technique of the reset waveform using the rectangular wave rising by the plurality of steps in Japanese Patent Application Laid-Open Publication No. 2000-172224 (Patent Document 1).

Patent Document 1: Japanese Patent Application Laid-Open Publication No. 2000-172224

### DISCLOSURE OF THE INVENTION

In the conventional PDP device, the application timing and waveform of the reset waveform using a step-wise rectangular wave is always constant regardless of the number of sustains and the like before reset, and thus a reset discharge by the step-wise rectangular wave itself becomes weak and unstable when the number of sustains before reset is small and the sustain discharge is relatively weak and unstable, thereby lacking in the display stability.

More specifically, first, in the subfield, the sustain discharge at the beginning immediately after an operation of an address period is unstable and does not satisfy a desired state for the plurality of sustain discharges of the sustain period. After a while with repeating the sustain discharges, the sustain discharge is stabilized and becomes the desired state. Thus, when the number of sustains of the sustain period is relatively large, the operation of the reset period starts with the sustain discharge being stabile, whereby the reset discharge becomes stable. However, if the number of sustains of the sustain period is relatively small, the operation of the reset period starts with the sustain discharge being unstable, whereby the reset discharge becomes unstable. Accordingly, drawbacks in display such that the reset discharge is not generated at a target cell are posed.

In view of the above-mentioned problems, an object of the present invention is to provide a technique capable of enhancing performance of the reset operation by the reset waveform using the step-wise rectangular wave to obtain stable display characteristics in the subfield drive control of a PDP device.

The typical ones of the inventions disclosed in this application will be briefly described as follows. To achieve the abovesaid object, the present invention provides a technique of a PDP device including an AC-type PDP to display images through a subfield method and an ADS (Address-, Display-period Separation) method, and the technique having the following technical means. The PDP is configured including an X electrode, a Y electrode, and an address electrode. A field corresponding to a display area of the PDP is configured by a plurality of subfields, and the subfield is configured by the operation of respective periods of reset, address, and sustain as the ADS method. A reset waveform using a step-wise rectangular wave is applied in the reset period.

In the present PDP driving method and device, to reliably perform the operation (reset discharge) of the reset period in the subfield, an application timing of part of the waveform (second step and thereafter) of the rectangular wave of n-steps is shifted according to the number of sustains (number of sustains discharges, number of unit sustain pulse applications, application time length, and the like) before the reset operation (in the immediately previous subfield) in the reset waveform using the rectangular wave rising by a plurality of (n) steps in a step-wise manner. According to such control, a shape of the tilt (rising) of the entire reset waveform including the rectangular wave is made steep, so that the reset discharge at the target cell is reliably and stably generated.

As for the condition, it is determined whether it is the case where the number of sustains of the immediately previous subfield is large (first condition) or the case where the number of sustains of the immediately previous subfield is small (second condition). For instance, as for the second condition, the case where the number of sustains of the immediately previous subfield is absolutely small or relatively reduced (e.g., reduced by a predetermined extent with respect to the maximum value) and the like are detected.

In particular, when the second condition is satisfied, the application timing of part of the rectangular wave of n-steps, that is, one or more of the second step and thereafter (2 to n) of the partial waveforms are accordingly advanced compared to the application timing of the waveform in the first condition. In the present control, the application timing and the shape of rectangular wave have at least two types by the first condition and the second condition.

The rectangular wave of n-steps is configured as a rectangular wave rising in two steps using an LC resonance and a voltage clamp in a driver circuit, or a rectangular wave of three-steps using a voltage combination clamp. An output circuit of the reset waveform including the rectangular wave is configured in the driver circuit of the Y electrode. The control of changing the timing of the voltage clamp of the second step or thereafter is performed in the present output circuit. In the case of the reset operation targeting on an ON cell of the subfield, a peak value (Vr) of the whole of the rectangular wave of n-steps is the same as a peak value (Vs) of a sustain voltage.

The effects obtained by typical aspects of the present invention will be briefly described below. According to the present invention, performance of the reset operation by the reset waveform using a step-wise rectangular wave is enhanced and a stable display characteristic can be obtained in the subfield drive control of a PDP device.

### BRIEF DESCRIPTIONS OF THE DRAWINGS

FIG. 1 is a diagram showing an overall configuration of a PDP device according to an embodiment of the present invention;

FIG. 2 is a diagram showing a configuration example of a PDP in the PDP device according to the embodiment of the present invention;

FIG. 3 is a diagram showing a configuration of a field of the PDP drive in the PDP device according to the embodiment of the present invention;

FIG. 4 is a diagram showing a configuration example of a basic drive waveform of a subfield in the PDP device according to the embodiment of the present invention;

FIG. 5 is a diagram showing a drive waveform and a light emission in the case where a number of sustains of an immediately previous subfield is large (first condition) in a PDP device according to a first embodiment of the present invention;

FIGS. 6A to 6B are diagrams showing drive waveforms and light emission in the case where the number of sustains of the immediately previous subfield is small (second condition) in the PDP device according to the first embodiment of the present invention, where FIG. 6A shows the case where the drive waveform is not changed similarly to the prior art, and FIG. 6B shows the case where the drive waveform is changed;

FIG. 7 is a diagram showing a configuration example of an output circuit of a reset waveform using a rectangular wave in the driver circuit of the Y electrode in the PDP device according to the first embodiment of the present invention;

FIGS. 8A to 8D are diagrams showing the output of the reset waveform by a switch control of the reset waveform output circuit in the PDP device according to the first embodiment of the present invention;

FIG. 9 is a diagram showing a drive waveform and a light emission in case where the number of sustains of the immediately previous subfield is large (first condition) in the PDP device according to a second embodiment of the present invention;

FIGS. 10A to 10B are diagrams showing a drive waveform and a light emission in the case where a number of sustains of an immediately previous subfield is small (second condition) in a PDP device according to a second embodiment of the present invention, where FIG. 10A shows the case where a drive waveform is not changed similarly to the prior art, and FIG. 10B shows the case where the drive waveform is changed;

FIG. 11 is a diagram showing a configuration example of an output circuit of a reset waveform using a rectangular wave in a driver circuit of a Y electrode in the PDP device according to the second embodiment of the present invention; and

FIGS. 12A to 12D are diagrams showing the output of the reset waveform by a switch control of the reset waveform output circuit in the PDP device according to the second embodiment of the present invention.

### BEST MODE FOR CARRYING OUT THE INVENTION

Hereinafter, embodiments of the present invention will be described in detail with reference to the accompanying drawings. Note that, components having the same function are denoted by the same reference symbols throughout the drawings for describing the embodiment, and the repetitive description thereof will be omitted.

### First Embodiment

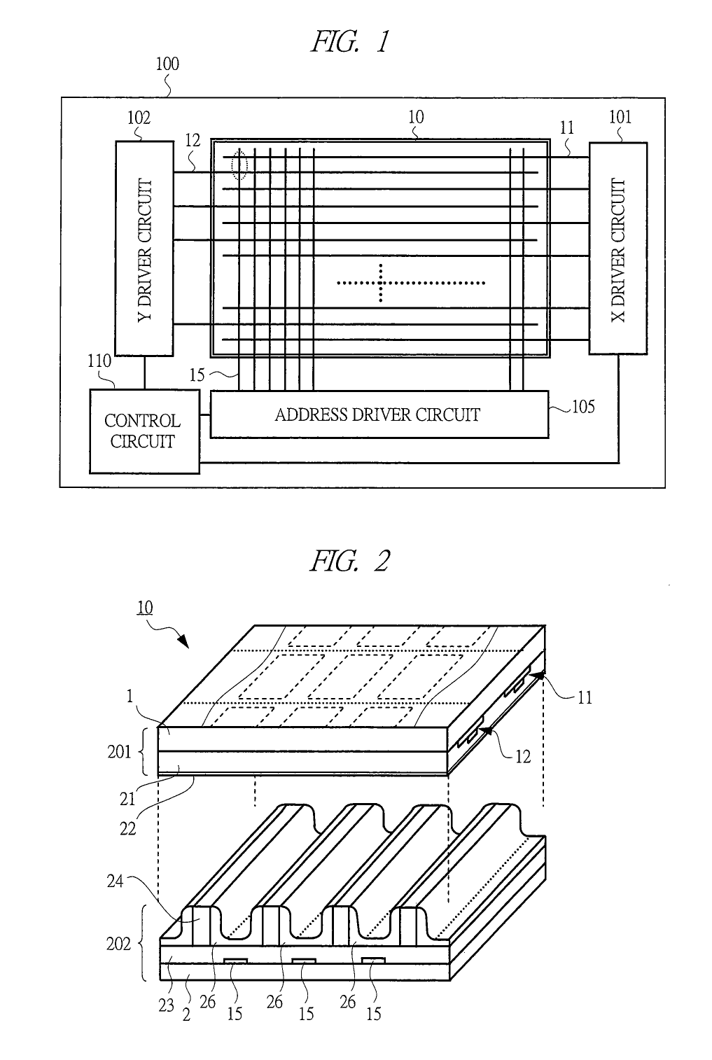

A PDP device according to a first embodiment of the present invention will be described with reference to FIGS. 1 to 8. The first embodiment has features in using a two-step rectangular wave as a reset waveform, and quickening the timing of the rise of the second step of the rectangular wave according to the magnitude of the number of sustains in the immediately previous subfield (abbreviated as SF).

<PDP Device>

First, in FIG. 1, an overall configuration of the PDP device (PDP module) 100 will be described. The PDP device 100 is mainly configured including a PDP (display panel) 10 and a circuit unit for driving and controlling the same. The PDP module has a configuration in which the PDP 10 is adhered and held onto a chassis (not shown), the circuit unit is configured by an IC and the like, and the PDP 10 and the circuit unit are electrically connected. The PDP module is accommodated in an external chassis, thereby configuring the PDP device (product set).

An X electrode (sustain electrode) 11, a Y electrode (scan electrode) 12 and an address electrode 15 of the PDP 10 are connected to corresponding driver circuits (drivers): an X driver circuit 101; a Y driver circuit 102; and an address driver circuit 105, and driven by a voltage waveform of corresponding drive signals. Each driver (101, 102, 105) is connected to a control circuit 110 and controlled by a control signal. The control circuit 110 controls the entire PDP device 100 including each driver, and generates control signals for driving the PDP 10, display data (SF data) and the like based on input display data (video signal), and outputs the same to each driver. A power supply circuit (not shown) supplies power to each circuit such as the control circuit 110.

<PDP>

Next, in FIG. 2, one example {AC type, surface discharge, (X, Y, A) three-electrode, X/Y alternate arrangement, and stripe-shaped rib configuration} of a structure of the PDP 10 is described. One portion corresponding to a pixel is shown. The PDP 10 is configured by having a structure on a front substrate 1 side mainly configured by glass (front plate 201) and a structure of a rear substrate 2 side (rear plate 202) combined facing each other, where the surround part is sealed and a discharge gas is encapsulated in the space.

In the front plate 201, a plurality of X electrodes (sustain electrodes) 11 and Y electrodes (scan electrodes) 12, which are electrodes (display electrodes) for performing repetitive discharge (sustain discharge) of the display, extend parallel to a first direction (horizontal direction) at a predetermined spacing, and are alternately and repeatedly formed in a second direction (vertical direction) on the front substrate 1. The display electrode (11, 12) group is covered by a first dielectric layer 21, and a surface facing a discharge space of the first dielectric layer 21 is covered by a protective layer 22 formed of MgO and the like. The display electrodes (11, 12) are respectively configured by a linear bus electrode formed of a metal, and a transparent electrode electrically connected to the bus electrode and forming a discharge gap between adjacent electrodes.

In the rear plate 201, a plurality of address electrodes 15 is formed extending parallel to a second direction on the rear substrate 2. The address electrode 15 group is covered by a second dielectric layer 23. On both sides of the address electrode 15, a barrier rib (vertical rib) 24 extending in the second direction is formed to divide the display area in a column direction. Further, a phosphor 26 of each color to be excited by ultraviolet ray and generating visible light of red (R), green (G), and blue (B) is applied distinctly per each column on an upper surface of the second dielectric layer 23 on the address electrode 15, and side surfaces of the barrier rib 24.

The front plate 201 and the rear plate 202 are adhered to each other so that the protective layer 22 and the upper surface of the barrier rib 24 are contacted with each other, and a discharge gas of Ne—Xe and the like is encapsulated in the space in between, thereby configuring the PDP 10. The display electrodes (11, 12) form a row (line) of the display by a pair of the X electrode 11 and the Y electrode 12 adjacent in the second direction, and furthermore, the address electrode 15 intersects the row so that a cell is formed in correspondence to a region divided by the barrier ribs 24, and a discharge is performed at the discharge gap of each cell. The pixel is configured by a set of R, G, and B cells. The PDP 10 has various structures according to driving methods, and the features of the present invention and embodiments can be applied to various types of PDP 10.

<Field>

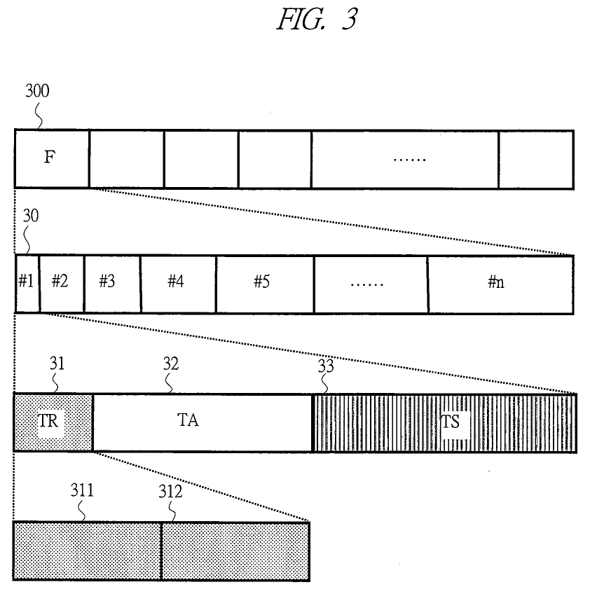

In FIG. 3, a configuration in a field (also referred to as frame) which is a display unit of a video image corresponding to the display area (screen) of the PDP 10 is described as a method of drive control of the PDP 10. The present driving method is one example of a general “address-, display-period separation method” (ADS). One field (field period) 300 is displayed in 1/60 second by way of example. The field 300 is configured by a plurality of (n) SF (also referred to as subframe) 30 temporally divided to express grayscale. Each SF 30 includes a reset period (TR) 31, a subsequent address period (TA) 32, and a subsequent sustain period (TS) 33. Each SF 30 of the field 300 is given a weighting by the length of the sustain period 33, that is, the number of sustains discharges (number of sustains), and the grayscale is expressed by light ON/OFF combinations of each SF 30 of the field 300.

As an outline of the drive, in the reset period 31, erase of charges formed in the sustain period 33 of the previous SF 30, and an operation (reset operation) of charge write (accumulation) and adjustment for preparing for an operation of the subsequent address period 32 are performed with respect to the cell group of the SF 30. In the address period 32, an operation (address operation) of selecting the lighted (ON)/non-lighted (OFF) cells in the cell group of the SF 30 is performed. In the sustain period 33, an operation (sustain operation) of generating repetitive discharges (sustain discharge) for display at the cells (target ON cell) selected in the immediately previous address period 32 is performed.

In the reset period 31, charges of the cell are adjusted by applying a reset waveform on the display electrodes (11, 12). The reset period 31 is configured by a first period 311 and a second period 312, where a charge write pulse is applied in the first period 311 and a charge adjustment pulse is applied in the second period 312 as the reset waveform. Accordingly, a small discharge (reset discharge) is generated at the cell, thereby ensuring generation of an address discharge in the subsequent address period 32.

In the subsequent address period 32, the discharge (address discharge) for selecting the target ON cell in the cell group of the SF 30 is performed. In the address period 32, the scan pulse is applied to the Y electrode 12 of an arbitrary row according to SF data, and the address pulse is applied to the selected address electrode 15 at the corresponding timing to generate the scan discharge to form wall charges at the target ON cell. As a scanning operation in the SF 30, the address operation of the Y electrode 12 of the first row from the top is first performed, and then the address operation is performed until the last row in a manner sequentially scanning the second row, and then the third row.

In the subsequent sustain period 33, the sustain pulse for alternately inverting polarities is repeatedly applied between the display electrodes (11, 12); (X−Y) of all the cells for the number of times (time period) corresponding to the weighting of the SF, so that the sustain discharge is generated at the cell selected in the immediately previous address period 32, thereby causing luminescence (light-ON) at the corresponding cell.

Note that, in this example, a method of forming charges in the target ON cell (write address method) is used as the addressing method. With respect to details of the waveform, various types can be applied according to driving methods.

<Basic Waveform>

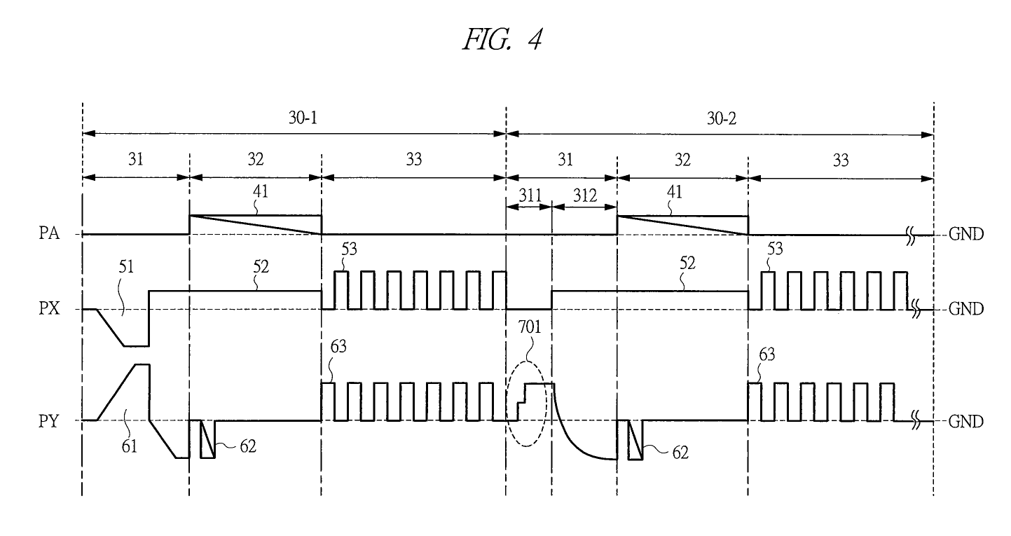

In FIG. 4, an example of a basic drive waveform in the drive control of the PDP 10 is described. PA, PX, and PY show outlines of the respective waveforms applied to the address electrode 15, the X electrode 11, and the Y electrode 12 in successive two SFs 30-1, 30-2 in the field. In particular, SF 30-2 using a reset waveform including a rectangular wave, and the previous SF 30-1 are shown.

In SF 30-1, the case of applying reset waveforms (51, 61) using an inclined wave on the X electrode 11, Y electrode 12 is shown with PX and PY in the reset period 31. The reset waveforms (51, 61) generate the reset discharge targeting on all the cells. In the subsequent address period 32, an address pulse 41 is applied with PA, a voltage 52 is applied with PX, and a scan pulse 62 is applied with PY to generate the address discharge at the selected cell. In the subsequent sustain period 33, the sustain pulses (53, 63) are applied for a predetermined number of sustains on the X electrode 11 and the Y electrode 12 with PX and PY to generate the sustain discharge.

In SF 30-2, the case of applying a reset waveform using a step-wise rectangular wave 701 on the Y electrode 12 is shown with PX and PY in the reset period 31. The reset waveform is configured such that, specifically, there are applied: the two-step rectangular wave 701 having positive polarity on the Y electrode 12 and a GND (ground) voltage on the X electrode 11 in the first period 311; and a negative slope waveform or lamp waveform on the Y electrode 12 and a voltage of a predetermined positive polarity on the X electrode 11 in the following second period 312. The reset waveform generates the reset discharge targeting on a specific cell. The specific cell is a cell (ON cell) lighted on by generating the sustain discharge in the sustain period 33 of the immediately previous SF 30-1. This reset waveform is applied in the same manner to all the cells of the SF, but generates the reset discharge only at the ON cell according to the state of the charges of the cell. Thus, in each embodiment, as a method of the reset operation taken as a premise technique, the reset waveform using a step-wise rectangular wave for generating the reset discharge targeting only on the ON cell rather than targeting on all the cells is applied. In this manner, unnecessary discharges (reset discharges at OFF cell) are thereby reduced, and the contrast of the screen can be enhanced compared to the reset method targeting on all the cells as in the reset operation of the SF 30-1.

Further, as the driving method, the reset waveform may be distinguishingly used according to the SF data etc., in such a way that the reset waveform using the inclined wave is used in the initial SF 30 of the field, and the reset waveform by the rectangular wave 701 is used in the other SFs 30.

In the conventional reset waveform using the step-wise rectangular wave in the reset period 31, the rising shape and timing are always constant irrespective of the number of sustains of the immediately previous SF. For instance, as a waveform for charge accumulation in the first period 311, in particular, the timing (clamp timing) of the rising of the second step is made always the same in the reset waveform of the rectangular wave 701 rising in two-steps using the LC resonance and the voltage clamp.

<Reset Waveform (1-1)>

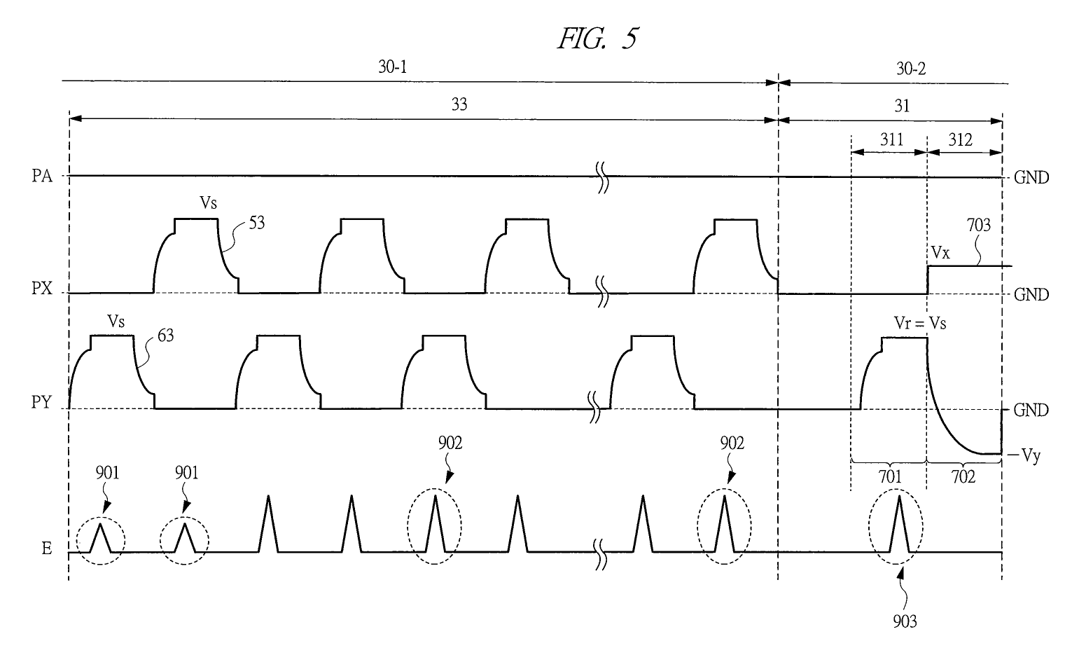

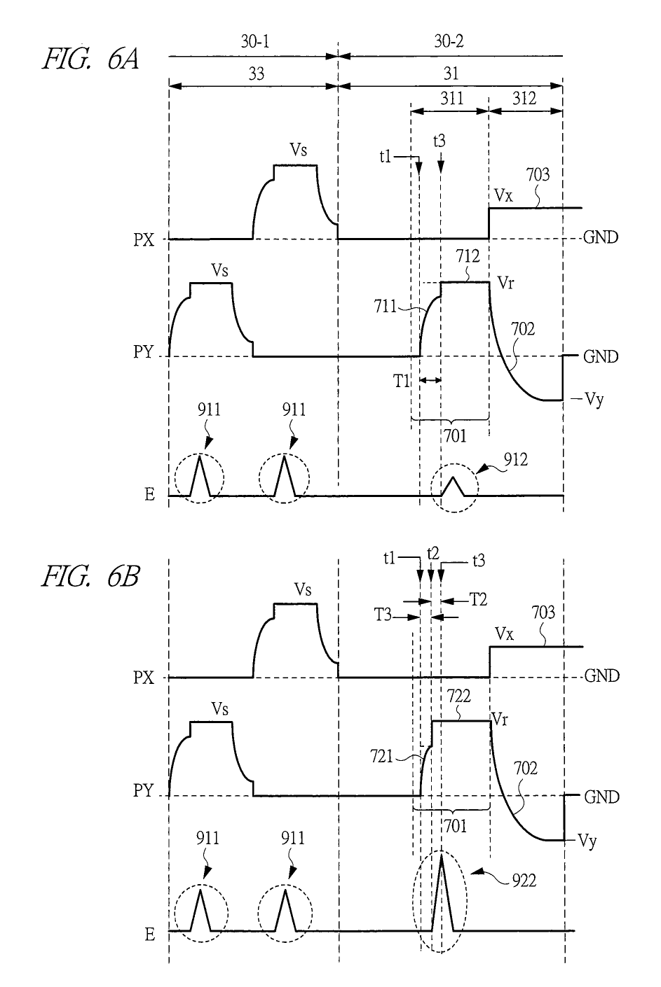

Next, in FIG. 5 and FIG. 6A-6B, the reset operation and control in the first embodiment will be described. FIG. 5 shows a first reset waveform in the SF 30-2 in the case where the number of sustains of the immediately previous SF 30-1 is large (first condition), and in FIG. 6, in the case where the number of sustains of the immediately previous SF 30-1 is small (second condition), FIG. 6A shows a first reset waveform that is not changed in the SF 30-2 similarly to the prior art and FIG. 6B shows a second reset waveform that is changed in the SF 30-2. In the present embodiment, at least two types of conditions and the reset waveforms corresponding thereto are provided for the case where the number of sustains of the sustain period 33 of the immediately previous SF 30-1 is large (FIG. 5) and small (FIG. 6).

In FIG. 5, each waveform of the sustain period 33 of the immediately previous SF 30-1 and each waveform of the reset period 31 of the subsequent SF 30-2 are shown with PA, PX, and PY, where E shows the state of luminescence of corresponding various discharges (sustain discharge and reset discharge). In the sustain period 33 of the immediately previous SF 30-1, the sustain discharge is repetitively generated by the application of the sustain pulses (53, 63) on the X electrode 11 and the Y electrode 12. At the beginning, in particular, the first and second times of the sustain period 33, an unstable sustain discharge 901 is generated as being immediately after the address operation, and thus the luminescence amount is small. After repeating the sustain discharge, a stable sustain discharge 902 is generated, and the luminescence amount reaches a desired amount.

In the first embodiment, the reset waveform including the rectangular wave 701 rising in two-steps is used in the reset period 31. In PY, the rectangular wave 701 is applied to the Y electrode 12 in the first period 311 of the reset period 31, and thereafter, the negative slope waveform 702 is applied in the second period 312. The slope waveform 702 is a waveform that is continuously lowered to a potential (−Vy) of a predetermined negative polarity from the predetermined peak value (peak value (Vr=Vs) of the entire rectangular wave 701). In correspondence to PY, in PX, the GND voltage is applied in the first period 311 and a positive voltage (Vx) 703 is applied in the second period 312 to the X electrode 11.

In the present reset method targeting the ON cell, it is designed such that the peak value (Vr) of the whole of the rectangular wave 701, in other words, the potential after the rising of the second step becomes the same as the peak value (Vs) of the immediately previous sustain pulses (53, 63). Thus, a stable reset discharge 903 is generated between the X electrode 11 and the Y electrode 12 (X-Y) at the ON cell (cell turned ON in the immediately previous SF 30-1) of the SF 30-2 by way of actions of the charge accumulation by the waveform of the first period 311 and the charge adjustment by the waveform of the second period 312. In the conventional reset method targeting all the cells, the peak value is designed so as to become larger than the peak value (Vs) of the sustain pulse as shown in the reset waveforms (51, 61) of the SF 30-1 in FIG. 4.

<Reset Waveform (1-2)>

In FIG. 6, FIG. 6A represents the case where the reset waveform is constant (first reset waveform) and not changed regardless of the number of sustains of the immediately previous SF 30-1 similarly to the prior art, in particular, the case where the timing of rising of the second step of the rectangular wave 701 is not changed. The two-step rectangular wave 701 is the same as the case of FIG. 5. In FIG. 6, FIG. B represents the case of the second reset waveform for changing the reset waveform of SF 30-2 according to whether the number of sustains of the immediately previous SF 30-1 is large (first condition) and small (second condition), which is a feature of the first embodiment.

In FIG. 6A, the number of sustains of the sustain period 33 of the immediately previous SF 30-1 is small, e.g., once (second condition), where an unstable sustain discharge 911 is generated as it is immediately after the address operation, and the period enters into the reset period 31 of the subsequent SF 30-2 as-is.

In the two-step rectangular wave 701 in the first period 311 of the reset period 31 of the SF 30-2, a waveform 711 of the first step is a waveform raised by the LC resonance at timing t1. A waveform 712 of the second step is a waveform raised to a predetermined voltage (Vr=Vs) by voltage clamp at timing t3 following the waveform 711 of the first step. A time (T1) of rising of the first step in the two-step rectangular wave 701 is designed to be within 2 μs (micro-second). Thus, since the waveform enters the reset period 31 with the unstable sustain discharge 911 being generated, the reset discharge 912 also becomes unstable, and it makes display defects to occur easily.

In FIG. 6B, a case of advancing the timing of rising of the second step of the rectangular wave 701 in the reset waveform when the number of sustains of the immediately previous SF 30-1 is small (second condition) is shown. In the first embodiment, the number of sustains of the immediately previous SF 30-1 is determined from the SF data etc., and detection is made that the number of sustains is small (second condition), and timing of rising clamp of the second step of the rectangular wave 701 is controlled by the control circuit 110.

With regard to determination of the number of sustains and detection of the condition, the determination and detection are made on the case where the number of sustains of the immediately previous SF 30-1 is absolutely large or the case where the number of sustains is relatively increased in the SF 30 as the first condition, or the determination and detection are made on the case where the number of sustains of the immediately previous SF 30-1 is absolutely small or the case where the number of sustains is relatively decreased in SF 30 as the second condition.

When the second condition is satisfied, the timing of rising of the waveform 712 of the second step of the rectangular wave 701 in the reset period 31 of the SF 30-2 is advanced by a predetermined time period (T2) from t3 to t2 compared to the case of the first condition. The application timing t1 of the rising of the waveform 711 of the first step of the rectangular wave 701 does not change. The time from the application of the first step to the application of the second step of the rectangular wave 701 is T1 (t3−t1) to T3 (t2−t1).

In the two-step rectangular wave 701 in the first period 311 in the reset period 31 of SF 30-2, a waveform 721 of the first step is a waveform raised at timing t1 by the LC resonance. A waveform 722 of the second step is a waveform raised to a predetermined voltage (Vr=Vs) at timing t2 by the voltage clamp. The time (T3) of rising of the first step in the two-step rectangular wave 701 is designed to be within 2 μs, for example.

Even in the reset period 31 with the unstable sustain discharge 911 being generated, the rising in the shape of the entire rectangular wave 701 is made steep by advancing the application timing of the second step of the rectangular wave 701 in the operation of the reset period 31 of SF 30-2 satisfying the second condition. Consequently, a stable reset discharge 922 is thereby generated.

<Modification Example (1)>

In the above control, while only the two types of switching by the first and second conditions and the reset waveforms are described, it is not limited thereto, and switchings by a plurality of conditions and reset waveforms may be performed. As a control example, the application timing of the second step of the rectangular wave 701 may be shifted forward or backward (increase or decrease the shifting time) linearly (e.g., determined with linear function) according to the number of sustains. A predetermined range, group, reference level and the like may be provided with regard to the number of sustains, and the application timing of the second step of the rectangular wave 701 may be shifted forward or backward according to these.

<Circuit (1)>

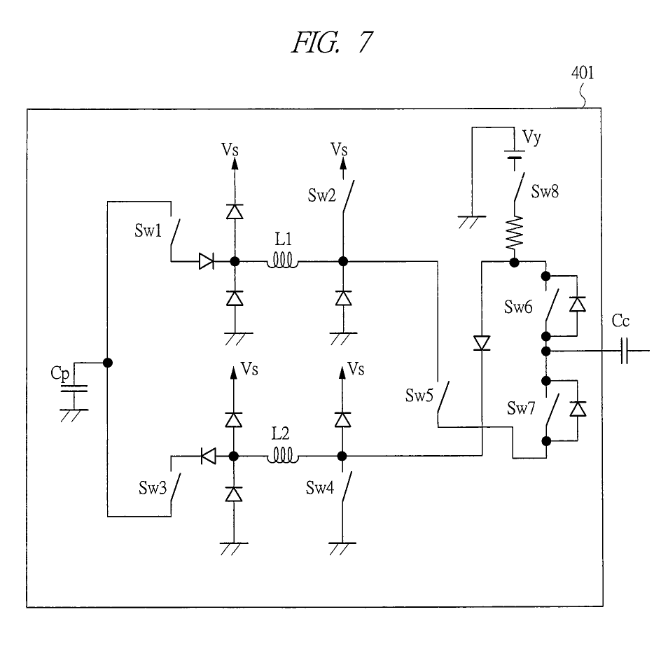

Next, in FIG. 7, a configuration example of the reset waveform output circuit corresponding to FIGS. 5 and 6 is described. A present output circuit 401 represents a case of configuring the reset waveform output circuit in the Y driver circuit 102. The present output circuit 401 is configured to include a sustain driver circuit (sustain pulse output circuit) and a scan driver circuit (scan pulse output circuit) and a power collecting circuit, where the first and second reset waveforms (rectangular reset waveforms) using the rectangular wave 701 of FIGS. 5 and 6, the scan pulse 62, and the sustain pulse 63 and the like can be output to the Y electrode 12 and the cell of the PDP 10.

Cc is a panel capacity corresponding to the cell of the PDP 10. Cp is a power recovery capacitor (power supply) in the power recovery circuit. SW1 to SW8 are switch elements capable of controlling ON(H)/OFF (L). L1 and L2 are coils, and Vs and Vy are power supplies for supplying a predetermined voltage.

<Switch Control (1)>

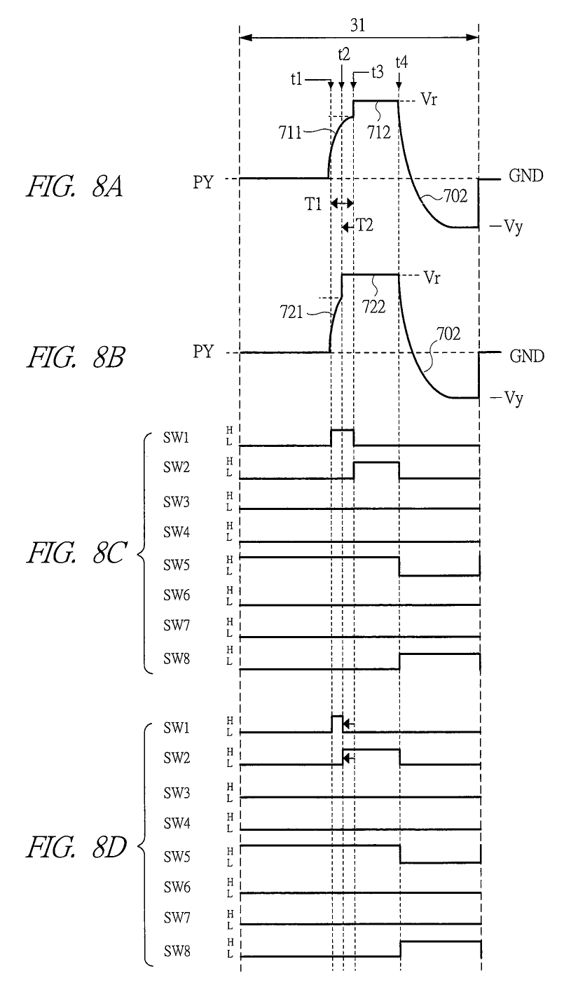

In FIGS. 8A-8D, output waveforms and switch control of switches (SW1 to SW8) corresponding to the output circuit 401 of FIG. 7 are shown. Here, FIG. 8A is the first reset waveform in the first condition corresponding to FIG. 5 and FIG. 6A, and FIG. 8B is the second reset waveform in the second condition corresponding to FIG. 6B. Furthermore, FIG. 8C is switch control upon outputting the FIG. 8A's first reset waveform, and FIG. 8D is switch control upon outputting the FIG. 8B's second reset waveform.

The case of outputting the first reset waveform of FIG. 8A is as follows. First, when outputting the rectangular wave 701 in the first period 311, the waveform 711 of the first step in the rectangular wave 701 is raised by generating the LC resonance with L1 and Cc by turning ON the SW1 at the timing t1, and the waveform 712 of the second step is raised by the voltage clamp to Vr=Vs by turning ON the SW2 and turning OFF the SW1 at timing t3, as shown in FIG. 8C. When outputting the slope waveform 702 in the second period 312, the voltage value is gently (gradually) lowered from Vs to −Vy by turning ON the SW8 and turning OFF the SW2, and turning OFF the SW5 at timing t4. During the reset period 31, the SW5 is turned ON and the other ones are OFF at first, and SW3, SW4, SW6 and SW7 are maintained being turned OFF.

The case of outputting the second reset waveform of FIG. 8B is as follows. First, when outputting the rectangular wave 701 in the first period 311, the waveform 721 of the first step in the rectangular wave 701 is raised by generating the LC resonance with L1 and Cc by turning ON the SW1 at timing t1 as in FIG. 8D, and then the waveform 722 of the second step is raised by the voltage clamp to Vr=Vs by turning ON the SW2 at timing t2 advanced by the time T2 from the timing t3. The subsequent operations are the same as the case of the first reset waveform.

Note that, in the present control, the SW1 is turned OFF simultaneously with the turning ON of the SW2 at timing t2 or t3, but it may be turned OFF after a short moment turning ON the SW2 so that the ON states overlap.

As described in the foregoing, according to the first embodiment, the reset discharge is reliably generated by the ON cell by the control of the reset waveform using the two-step rectangular wave 701, thereby ensuring a stable reset operation. Therefore, the stability of display can be enhanced. Since the reset waveform output circuit can be configured to use the conventional driver circuit, an additional configuration of an independent extra reset waveform output circuit is not necessary, and the abovementioned effects can be realized with suppressing the cost.

### Second Embodiment

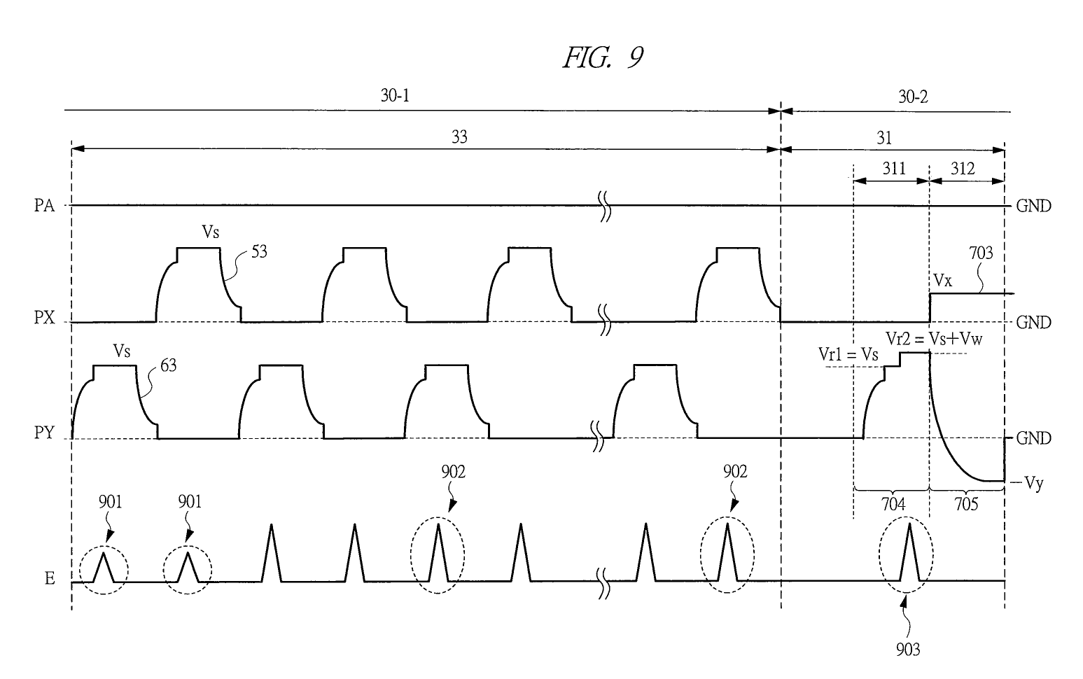

Next, a PDP device according to a second embodiment of the present invention will be described with reference to FIGS. 9 to 12. In the second embodiment, the basic configuration is the same as that of the first embodiment, and has a feature in that a three-step rectangular wave is used for the reset waveform, and the timing of rising of a third step of the rectangular wave is advanced according to the number of sustains at the immediately previous SF.

<Reset Waveform (2-1)>

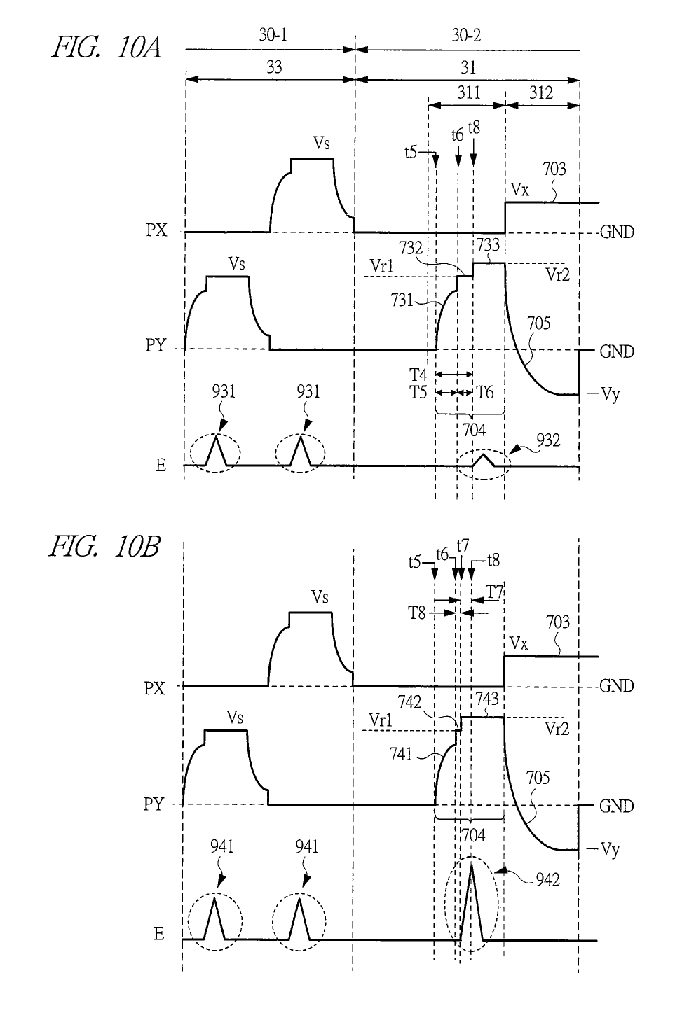

Next, the reset operation and the control of the second embodiment will be described in FIGS. 9 and 10. In FIG. 9, the first reset waveform in SF 30-2 when the number of sustains of the immediately previous SF 30-1 is large (first condition) is shown, and in FIG. 6A-6B, FIG. 6A represents the first reset waveform that does not change similar to the prior art, and FIG. 6B represents the changed second reset waveform of the SF 30-2 when the number of sustains of the immediately previous SF 30-2 is small (second condition) are shown.

In FIG. 9, the reset waveform including a rectangular wave 704 having a three-step rising is used in the reset period 31 in the second embodiment. In PY, the rectangular wave 704 is applied to the Y electrode 12 in the first period 311, and a negative slope waveform 705 is applied in the following second period 312. In the three-step rectangular wave 704, the first step is a waveform raised by the LC resonance similarly to the first embodiment. The second step is the waveform of the rise to a predetermined voltage (Vr1=Vs) by the voltage clamp. The third step is the waveform of the rise to a predetermined voltage (Vr2=Vs+Vw) by adding a predetermined voltage (+Vw). The slope waveform 705 is a waveform which is continuously lowered to a potential (−Vy) of a predetermined negative polarity from the predetermined peak value (peak value (Vr2=Vs+Vw) of the entire rectangular wave 704). In correspondence to PY, in PX, the GND voltage is applied in the first period 311 and the positive voltage (Vx) 703 is applied in the second period 312 with respect to the X electrode 11. The stable reset discharge 903 is generated at the ON cell of SF 30-2 by the action of charge accumulation by the waveform of the first period 311 and the charge adjustment by the waveform of the second period 312.

<Reset Waveform (2-2)>

In FIGS. 10A-10B, FIG. 10A represents a case where the reset waveform is constant (first reset waveform) and not changed, in particular, a case where the timing of rising of the third step of the rectangular wave 704 is not changed regardless of the number of sustains of the immediately previous SF 30-1 similarly to the prior art. The three-step rectangular wave 704 is the same as FIG. 9. In FIGS. 10A-10B, FIG. 10B represents a case of the second reset waveform for changing the reset waveform of SF 30-2 according to whether the number of sustains of the immediately previous SF 30-1 is large (first condition) and small (second condition), which is a feature of the second embodiment.

In FIG. 10A, the number of sustains of the sustain period 33 of the immediately previous SF 30-1 is small or once (second condition), where an unstable sustain discharge 931 is generated as being immediately after the address operation, and the period enters into the reset period 31 of the subsequent SF 30-2 as is.

In the three-step rectangular wave 704 in the first period 311 in the reset period 31 of the SF 30-2, a waveform 731 of the first step is a waveform raised by the LC resonance at timing t5. A waveform 732 of the second step is a waveform raised to a predetermined voltage (Vr1=Vs) by voltage clamp at timing t6 following the waveform 731 of the first step. A waveform 733 of the third step is a waveform raised from a predetermined voltage (Vr1=Vs) to a predetermined voltage (Vr2=Vs+Vw) by adding a voltage by voltage clamp at timing t8 following the waveform 732 of the second step. Thus, the period enters into the reset period 31 with the unstable sustain discharge 931 being generated, and thus the reset discharge 932 also becomes unstable, and display defects tend to easily occur.

In FIG. 10B, a case of advancing the timing of the third step of the rectangular wave 704 in the reset waveform when the number of sustains of the immediately previous SF 30-1 is small (second condition) is shown. In the second embodiment, the number of sustains of the immediately previous SF 30-1 is determined and a detection is made that the number of sustains is small (second condition), and the rising clamp timing of the third step of the rectangular wave 704 is controlled, similarly to the first embodiment.

When the second condition is satisfied, the timing of rising of the waveform 733 of the third step of the rectangular wave 704 in the reset period 31 of the SF 30-2 is advanced by a predetermined time (T6) from t8 to t7 compared to the case of the first condition. The application timing t5 of the rising of the waveform 741 of the first step of the rectangular wave 704, and the application timing t6 of the rising of the waveform 742 of the second step do not change. The time from the application of the second step to the application of the third step of the rectangular wave 704 is T6 (t8−t6) to T8 (t7−t6). The time (T4) for the rising to the third step in the three-step rectangular wave 704 is designed to be within 2 μs, for example.

Even in the reset period 31 with the unstable sustain discharge 911 being generated, the rising in the shape of the entire rectangular wave 704 becomes steep by advancing the application timing of the third step of the rectangular wave 704 in the operation of the reset period 31 of the SF 30-2 satisfying the second condition. A stable reset discharge 942 is therefore generated.

<Modification Example (2)>

Further, in the abovedescribed control, while the control only on the third step in the three-step rectangular wave 704 is shown, the timing of rising of only the second step or both the second step and the third step may be advanced. In the three-step rectangular wave 704, the second step and the third step are raised to a predetermined voltage (Vr2) at once, that is, the shape of the rectangular wave having three steps may be changed to that having two steps. Similar effects are obtained by making the rising of the entire rectangular wave 704 steep.

<Circuit (2)>

In FIG. 11, a configuration example of the reset waveform output circuit corresponding to FIG. 9A and FIG. 10A-10B is described. A present output circuit 402 represents a case where the reset waveform output circuit in configured in the Y driver circuit 102. The output circuit 402 has a configuration including driver circuits similar to the output circuit 401 of the first embodiment, where the first and second reset waveforms (rectangular reset waveforms) using the rectangular wave 704 of FIGS. 9 and 10, and the like are output to the Y electrode 12 and the cell of the PDP 10. SW1 to SW10 are switch elements capable of being controlled whose ON(H)/OFF(L), respectively. Vw is a power supply for supplying a predetermined voltage for voltage addition.

<Switch Control (2)>

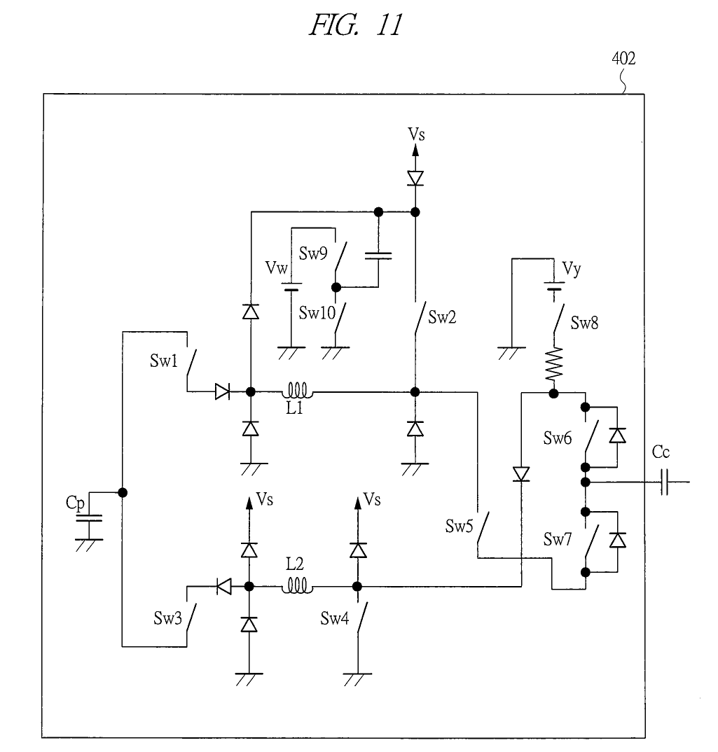

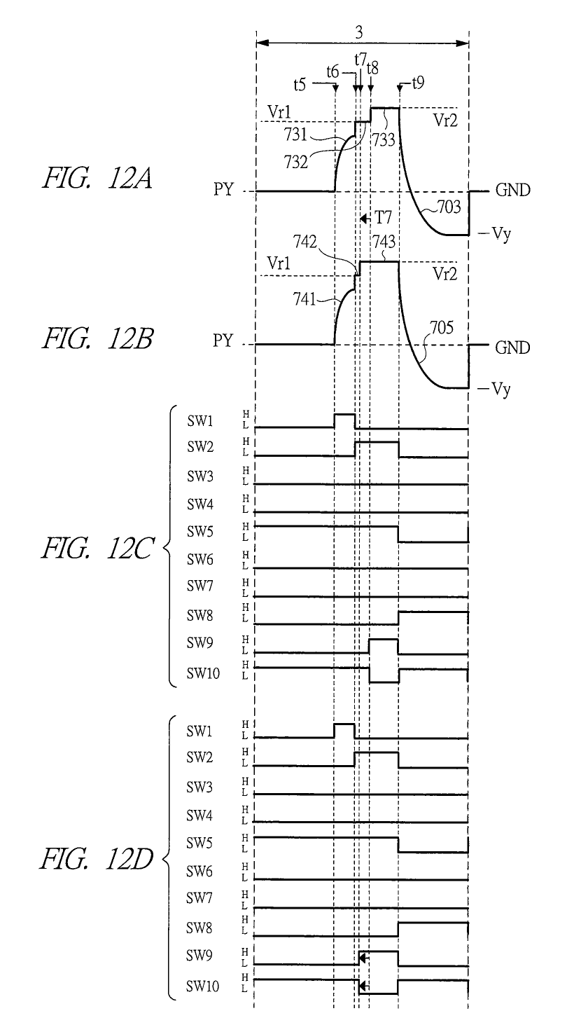

In FIGS. 12A-12D, the output waveforms and the switch control of the switches (SW1 to SW10) corresponding to the output circuit 402 of FIGS. 10A-10B are shown. Here, FIG. 12A represents the first reset waveform in the first condition corresponding to FIG. 9 and FIG. 10A, and FIG. 12B represents the second reset waveform in the second condition corresponding to FIG. 10B. Furthermore, FIG. 12C represents the switch control for outputting the FIG. 12A's first reset waveform, and FIG. 12D represents the switch control for outputting the FIG. 12B's second reset waveform.

The case of outputting the first reset waveform of FIG. 12A is as follows. First, when outputting the rectangular wave 704 in the first period 311, the waveform 731 of the first step in the rectangular wave 704 is raised by generating the LC resonance with L1 and Cc by turning ON the SW1 at the timing t5, and the waveform 732 of the second step is raised by the voltage clamp to Vr1=Vs by turning ON the SW2 and turning OFF the SW1 at the timing t6, as shown in FIG. 12C. The waveform 733 of the third step is raised by the voltage clamp to Vr2=Vs+Vw by turning ON the SW9 and turning OFF the SW10 at the timing t8. The switching between Vs and Vs+Vw is possible by turning ON/OFF the SW9. When outputting the slope waveform 705 in the second period 312, the voltage value is gently lowered from Vs+Vw to −Vy by turning ON the SW8 and turning OFF the SW9 etc. at the timing t9.

The case of outputting the second reset waveform of FIG. 12B is as follows. First, when outputting the rectangular wave 704 in the first period 311, the waveform 741 of the first step in the rectangular wave 704 is raised by generating the LC resonance with L1 and Cc by turning ON the SW1 at the timing t5 as in FIG. 12D, and then the waveform 742 of the second step is raised by the voltage clamp to Vr1=Vs by turning ON the SW2 and turning OFF the SW1 at the timing t6. At the timing t7 advanced by the time T2 from the timing t8, the waveform 743 of the third step is raised by voltage clamp to Vr2=Vs+Vw by turning ON the SW9 and turning OFF the SW10. The subsequent operations are the same as the case of the first reset waveform.

In the present control, the SW9 is turned ON after turning ON the SW2, but the second step and the third step of the rectangular wave 704 may be raised all at once to make the shape of two steps by turning ON the SW2 later than turning ON the SW9.

Therefore, according to the second embodiment, a stable reset operation is ensured and the stability of display can be enhanced, similarly to the first embodiment, by the control of the reset waveform using the three-step rectangular wave 704.

In the foregoing, the invention made by the inventors of the present invention has been concretely described based on the embodiments. However, it is needless to say that the present invention is not limited to the foregoing embodiments and various modifications and alterations can be made within the scope of the present invention.

### INDUSTRIAL APPLICABILITY

The present invention is applicable to a plasma display device for performing drive control of subfields and reset.

1. A plasma display panel driving method with respect to drive control of a field corresponding to a display area of a plasma display panel formed with an electrode group, and a subfield made by dividing the field into a plurality of subfields for grayscale expression, the method performing an operation of each period of reset, address, and sustain in the subfield, wherein,
in the reset operation of at least one subfield in the plurality of subfields,
the reset operation uses a reset waveform including a rectangular wave raised in a plurality of steps in a step-wise manner with respect to the electrode group; and
an application timing of a partial waveform of one or more steps at and after a second step in the rectangular wave for the reset operation is shifted according to a number of sustains in the sustain operation prior to the reset operation.

2. A plasma display panel driving method for driving a plasma display panel for moving image display, the method operating each period of reset, address, and sustain in a subfield in a drive control of the subfield made by dividing a field corresponding to a display area of the plasma display panel formed with an X electrode, a Y electrode, and an address electrode into a plurality of subfields for grayscale expression, wherein,
in the reset operation of at least one subfield in the plurality of subfields,
a reset waveform including a rectangular wave raised in a plurality of steps in a step-wise manner is applied on at least the Y electrode in the reset operation; a scan pulse is applied to the Y electrode and an address pulse is applied on the address electrode in the address operation; and a sustain pulse is applied for a number of sustains per the subfield on the X and Y electrodes in the sustain operation, and
an application timing of a partial waveform of one or more steps at and after a second step in the rectangular wave is shifted according to a number of sustains in the sustain operation in an immediately previous subfield of the reset operation.

3. The plasma display panel driving method according to claim 2, wherein,
when the number of sustains previous to the reset operation is small or reduced, the application timing of the partial waveform of the rectangular wave is advanced compared to the case where the number of the sustain is large or increased.

4. The plasma display panel driving method according to claim 3, wherein
the application timing of the partial waveform of the rectangular wave is linearly advanced according to a smallness or an extent of reduction of the number of sustains.

5. The plasma display panel driving method according to claim 3, wherein
the application timing of the partial waveform of the rectangular wave is advanced in a step-wise manner according to a smallness or an extent of reduction of the number of sustains.

6. The plasma display panel driving method according to claim 3, wherein
the rectangular wave is a waveform raised in two steps as a whole, where a first step is a waveform by LC resonance, and a second step is a waveform by voltage clamp to a first voltage.

7. The plasma display panel driving method according to claim 3, wherein
the rectangular wave is a waveform raised in three steps as a whole, where a first step is a waveform by LC resonance, a second step is a waveform by voltage clamp to a first voltage, and a third step is a waveform by voltage clamp of addition of a second voltage; and,
when the number of sustains previous to the reset operation is small or reduced, the application timing of the partial waveform of the rectangular wave is advanced or raised at once to reduce the number of steps compared to the case where the number of sustains is large or increased.

8. The plasma display panel driving method according to claim 3, wherein
the reset waveform of the reset operation is a waveform having a shape for generating a reset discharge targeting only on a cell discharged by the sustain operation previous to the reset operation.

9. The plasma display panel driving method according to claim 8, wherein
a peak value of the overall rectangular wave in the reset waveform is the same as a peak value of a sustain pulse applied in the sustain operation.

10. The plasma display panel driving method according to claim 3, wherein
a slope waveform or a lamp waveform whose voltage value is continuously lowered from any voltage smaller than or equal to the peak value of the overall rectangular wave to a predetermined negative voltage value is applied as a waveform subsequent to the rectangular wave in the reset waveform.

11. The plasma display panel driving method according to claim 3, wherein
time taken to rise from a first step to a last step of the rectangular wave in the reset waveform is within two microseconds.

12. A plasma display device comprising: a plasma display panel formed with X electrode, Y electrode, and an address electrode; and a circuit unit for performing operation of each period of reset, address, and sustain in a subfield in a drive control of the subfield made by dividing a field corresponding to a display area of the plasma display panel into a plurality of subfields for grayscale expression, wherein,
in the reset operation of at least one subfield in the plurality of subfields,
a reset waveform including a rectangular wave raised in a plurality of steps in a step-wise manner is applied on at least the Y electrode in the reset operation; a scan pulse is applied to the Y electrode and an address pulse is applied on the address electrode in the address operation; and a sustain pulse is applied for a number of sustains per the subfield on the X and Y electrodes in the sustain operation, and
an application timing of a partial waveform of one or more steps at or after the second step in the rectangular wave is shifted according to number of sustains in the sustain operation of an immediately previous subfield of the reset operation.

13. The plasma display device according to claim 12, wherein,
when the number of sustains previous to the reset operation is small or reduced, the application timing of the partial waveform of the rectangular wave is advanced compared to the case where the number of the sustains is large or increased.
